(19) United States
(12) Patent Application Publication
(10) Pub. No.: US 2015/0191948 A1
(43) Pub. Date: Jul. 9, 2015

(54) DIGITAL DOOR LOCK DEVICE

(71) Applicant: SEGOS CO., LTD., Incheon (KR)

(72) Inventors: Kye A. Son, Seoul (KR); Sung-Min Hong, Seoul (KR)

(21) Appl. No.: 14/419,175

(22) PCT Filed: Aug. 2, 2013
(86) PCT No.: PCT/KR2013/006979

§ 371 Date: Feb. 2, 2015

(30) Foreign Application Priority Data
Aug. 2, 2012 (KR) 10-2012-0084711
Aug. 2, 2012 (KR) 10-2012-0084713
Aug. 2, 2012 (KR) 10-2012-0084714

(51) Int. Cl. E05C 3/16

(52) U.S. Cl. CPC E05C 3/16

(57) ABSTRACT

A digital door lock is disclosed. More particularly, a digital door lock is provided that digitally operates and can be easily installed on all kinds of doors with a door knob such as interior and exterior doors and chassis doors, without damaging existing doors with a mechanical door lock.

### TECHNICAL FIELD

The present invention relates to a digital door lock, and more particularly, to a digital door lock that digitally operates and can be easily installed on all kinds of doors with a door knob such as interior and exterior doors and chassis doors, without damaging existing doors with a mechanical door lock.

### BACKGROUND ART

In general, door locks have been increasingly installed on the doors of houses, companies, and stores for crime prevention and security, and recently, mechanical door locks have been replaced with digital door locks.

In the related art, a way of touching an electronic touch panel with an electronic key, a way of inputting a combination by pressing key pads using mechanical switches such as a tact switch or a membrane switch, and a way of using fingerprints have been typically used in order to operate digital door locks.

Door locks of the related art largely include an outer unit mounted on the outer side of a door and having an exterior handle, an inner unit mounted on the inner side of the door and having an interior handle, a mortise disposed between the outer unit and the inner unit and having a dead bolt and/or a latch bolt moving with rotation of the handles, and a rotation transmission unit disposed between the exterior unit and the mortise and transmitting a rotation force of the handle on the exterior unit to the mortise.

In order to install such door locks of the related art on a door, it was required to structurally combine the exterior unit and the interior unit with each other and form a screw hole for additionally inserting a screw in the door, a wire hole for inserting a wire, and a through-hole for embedding a mortise in the door, for the purpose of wiring for internal electric circuit devices.

Accordingly, in order to replace a mechanical door lock on a door with a digital door lock, the door is necessarily damaged by the screw hole and the wire hole. Further, since a user has difficulty in installing a digital door lock in person, an additional cost for a specialist installing it is required and it is difficult to disassemble and reassemble it for moving in and out.

Further, when such digital door locks of the related art are installed on wooden doors in an interior, there is a large problem in that the doors may be seriously damaged due to carelessness in drilling for forming a screw hole or a wire hole in the doors. Accordingly, using the door locks of the related art is limited at present to the front doors or the exterior doors of offices.

Further, the bodies of the digital door locks of the related art are made of zinc, aluminum, reinforced glass, or plastic, so they have a defect of being damaged by shock over a predetermined strength, so they are vulnerable to security and a fire.

Therefore, there is a need for developing a digital door lock that can be easily installed only with a driver without damaging to an exterior door and an interior door equipped with such mechanical door locks and that has enhanced security and durability and is safe against a fire, using steel.

Further, according to the digital door locks of the related art, a lever is positioned in some cases at the left side or the right side of a door to be easily rotated in accordance with the open direction of the door.

When a left-handed lever is set to rotate clockwise and a right-handed lever is set to rotate counterclockwise, it is impossible to freely select left-handed/right-handed types for a lever in the open direction of a door, when selecting the position and installing it in accordance with the rotation direction of the lever.

Further, according to the digital door locks of the related art, a rotation force by a handle or a lever is transmitted to a locking unit in the digital door locks, so there is a problem in that the components of the locking device are damaged by mechanical friction or shock and the durability is deteriorated due to accumulated fatigue.

Further, according to the digital door locks of the related art, a circuit unit and an authentication unit are disposed in the door lock main body, so the main body needs to be manufactured large, and a steel lever is designed to be limited to the function of a lever itself, so it is difficult to be equipped with an authentication unit and a circuit unit.

(Patent Document 1) Korean Patent No. 10-0446255

### DISCLOSURE

### Technical Problem

An object of the present invention is to provide a digital door lock that allows for selection of left-handed/right-handed levers, depending on the open direction of a door, and accordingly that can be freely installed.

### Technical Solution

According to an aspect of the present invention, a digital door lock includes: a pair of door lock main bodies that are combined with rotatable levers and disposed on an interior side and an exterior side of a door; and a rotary connection module that is connected with the levers and rotatably combined with the door lock main bodies to transmit a rotation force of the levers to the door latch module, in which the door lock main bodies each include: a rotary housing that is disposed between the levers and the rotary connection module and has a left-handed lever section for transmitting a clockwise rotation force of the levers to the rotary connection module and a right-handed lever section for transmitting a counterclockwise rotation force of the levers to the rotary connection module; and a section moving portion that is disposed at side of the rotary housing to be moveable to any one of the left-handed lever section and the right-handed lever section of the rotary housing, and is moved in any one of the left-handed lever section and the right-handed lever section.

The left-handed lever section and the right-handed lever section may be formed in the shape of a groove circumferentially on the outer side of the rotary housing, and a neutral section through which a section moving portion can move to the left-handed lever section and the right-handed lever section may be formed between the left-handed lever section and the right-handed lever section.

The door lock main body may further include a door lock body that has a rotary coupling hole in which the lever and the rotary housing are rotatably inserted, and has a locking portion groove in which the section moving portion is disposed and that communicates with the rotary coupling hole.

The section moving portion may include: a rotation-setting support that is disposed in the locking portion groove and protrudes to the rotary coupling hole; and a rotation-setting spring that is disposed in the locking portion groove and supports the rotation-setting support to an inner wall of the door lock body.

The door lock main body may further include a rotary return unit that is combined with the rotary housing, is disposed on the door lock body, and returns the lever to the initial position within the left-handed lever section and the right-handed lever section.

The rotary return unit may include: a rotary plate that is combined with the rotary housing and has a rotary locking protrusion locked to the rotary housing; a rotary return arm that is connected to the rotary plate and extends to the outer side of the door lock body; a spring locking plate that is combined with the rotary return arm; and a rotary return spring that is disposed circumferentially on the door lock body and supports the spring locking plate.

The rotary return spring may be arranged in a pair on the outer side of the door lock body with the spring locking plate therebetween to return the lever to correspond to the left-handed lever section and the right-handed lever section.

The door lock main body may further include: a return path provider that is combined with the door lock body and provides a spring return path along a rotation path of the spring locking plate so that a pair of rotary return springs are circumferentially arranged; and a spring cover that is combined with the return path provider and prevents the pair of rotary return springs from separating from the spring return path.

The rotary connection module may be rotatably inserted in a slide passage formed in the rotary housing, and a pressing spring that supports the rotary connection module may be disposed in the slide passage of the rotary housing.

The rotary housing may have a wire groove divided from the slide passage by a separation wall.

### Advantageous Effects

According to an aspect of the present invention, a rotary housing that is installed on a door lock main body and combined with a lever has a left-handed section and a right-handed section and a section changer can be moved to the left-handed section and the right-handed section in assembling, such that it is possible to provide adaptability for installation capable of selecting left-handed/right-handed levers for the open direction of a door.

Further, according to another aspect of the present invention, since the locking/unlocking module has the slip gear unit, which is normally engaged and operated at torque less than a predetermined level and idles transmission torque by generating slip at torque over a predetermined level, when a rotation torque by a handle or a lever is transmitted to a locking device disposed therein, it is possible to not only prevent components of the locking device from being damaged by mechanical wear, shock, or accumulated fatigue, but reduce power consumption by preventing overload on the motor. Further, a rotation force is transmitted from the clutch unit to the gear portion of the motor even if it is connected to a mechanical lock, so it is possible to prevent wear of the gear portion of the reducer.

According to another aspect of the present invention, when the circuit and the operation button module are installed on the lever, the authentication buttons of the operation button module are fixed to the operation button body, so that the authentication buttons can be easily inserted in the lever without separating by the button elastic member, and accordingly, it is possible to provide a more compact configuration for installing a circuit and an authentication unit on a lever. Further, according to another aspect of the present invention, since it is possible to use a metallic pipe that can be easily purchased and has high durability as a lever, manufacturing is easy and security and durability of a digital door lock can be increased.

### DESCRIPTION OF DRAWINGS

FIG. 1 is a perspective view showing a door lock according to an embodiment of the present invention mounted on a door.

FIG. 2 is an exploded view of the door lock according to an embodiment of the present invention.

FIG. 3 is an exploded view showing a rotary connection module separated from door lock main bodies shown in FIG. 2.

FIG. 4 is a perspective view of an assembly of a rotary housing and the rotary connection module shown in FIG. 3.

FIG. 5 is an exploded view showing the rotary housing and the rotary connection module shown in FIG. 4.

FIG. 6 is a perspective view of the rotary housing shown in FIG. 5.

FIG. 7 is a perspective view of a locking stopper combined with the rotary housing shown in FIG. 5.

FIG. 8 is a perspective view of the rotary connection module shown in FIG. 5.

FIG. 9 is an exploded view of the rotary connection module shown in FIG. 8.

FIG. 10 is an exploded view showing the combination relationship between the rotary housing and the lever shown in FIG. 1.

FIG. 11 is a front view showing a rotary return unit with a door lock main body separated and the lever of FIG. 1 in a neutral position.

FIG. 12 is a front view showing rotation of the lever shown in FIG. 11.

FIG. 13 is a front view showing rotation of a rotary plate of the rotary return unit by the rotary housing that rotates with the lever shown in FIG. 12.

FIG. 14 is a front view showing returning of the lever by the rotary return unit shown in FIG. 13.

FIG. 15 is an exploded view showing locking/unlocking module of the door lock according to an embodiment of the present invention.

FIG. 16 is a perspective view of the locking/unlocking module of FIG. 15.

FIG. 17 is an exploded view showing a slip gear unit separated from a driving unit of the locking/unlocking module of FIG. 16.

FIG. 18 is a top perspective view of a clutch unit of the locking/unlocking module of FIG. 16.

FIG. 19 is an exploded perspective view showing a slip gear and a gear mount of the slip gear unit of the locking/unlocking module of FIG. 16.

FIG. 20 is a front view showing a clutch pin of the locking/unlocking module of FIG. 16 inserted in the rotary housing.

FIG. 21 is a front view showing the clutch pin of the locking/unlocking module of FIG. 20 separated from the rotary housing.

FIG. 22 is a front view showing the clutch pin separated from the rotary housing by pressing a cam guide of the clutch unit with a locking cam of FIG. 15.

FIG. 23 is an exploded view showing an operation button module separated from the lever of FIG. 1.

FIG. 24 is a perspective view showing a coupling tool combined with the operation button module of FIG. 23.

FIG. 25 is a perspective view showing an operation button body of the operation button module of FIG. 23.

FIG. 26 is a perspective view showing an authentication button of the operation button module of FIG. 23.

FIG. 27 is a bottom perspective view showing the coupling tool combined with the operation button module of FIG. 23.

FIG. 28 is an exploded perspective view showing a door lock fastening unit according to an embodiment of the present invention.

FIG. 29 is an exploded perspective view of a door lock equipped with the door lock fastening unit according to an embodiment of the present invention.

FIG. 30 is an exploded perspective view of a distance adjustment joint portion of FIG. 29.

FIG. 31 is an exploded perspective view of a fastening bolt of the door lock fastening unit of FIG. 29.

FIG. 32 is a perspective view of a door main body distance adjustment members and the fastening bolt of the door lock fastening unit of FIG. 28.

FIG. 33 is a perspective view showing another embodiment of the rotary housing and the rotary connection module of FIG. 2.

FIG. 34 is an exploded view of FIG. 33.

### BEST MODE

According to an aspect of the present invention, a rotary housing that is installed on a door lock main body and combined with a lever has a left-handed section and a right-handed section and a section changer can be moved to the left-handed section and the right-handed section in assembling, such that it is possible to provide adaptability for installation capable of selecting left-handed/right-handed levers for the open direction of a door. It is necessary to refer to the accompanying drawings showing preferred embodiments of the present invention and those shown in the drawings in order to fully understand the present invention, operational advantages of the present invention, and objects accomplished by implementing the present invention.

Hereinafter, the present invention will be described in detail by describing a preferred embodiment of the present invention with reference to the accompanying drawings. Like reference numerals indicate like components in the drawings.

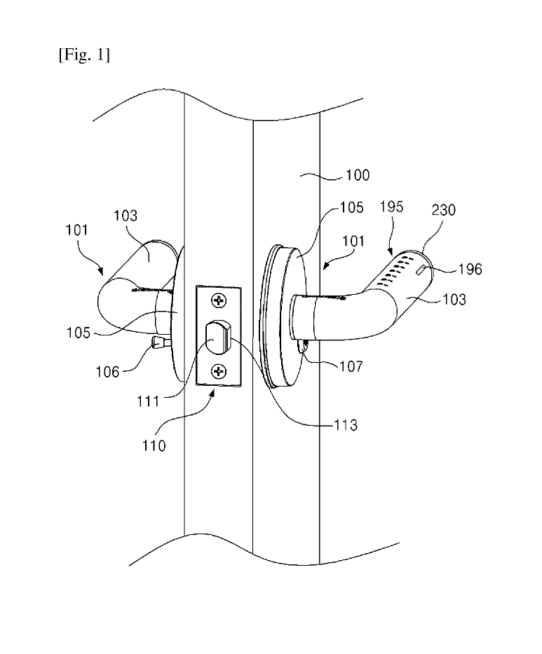

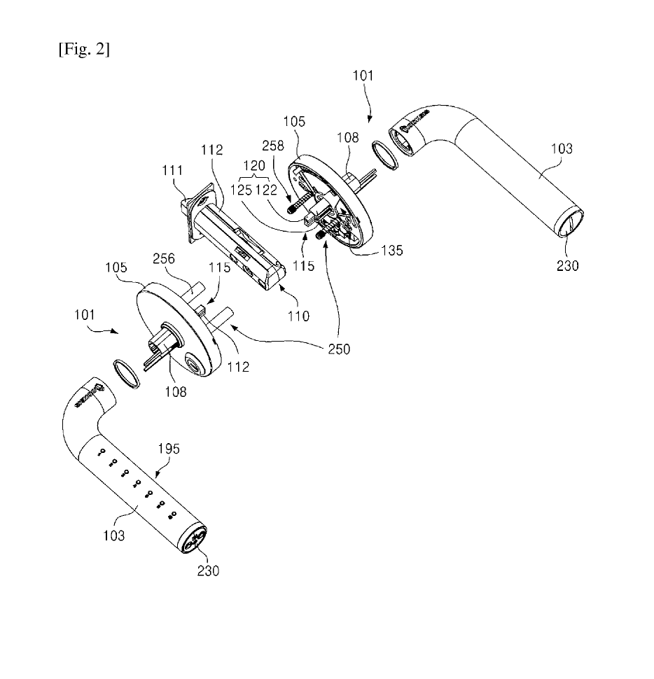

FIG. 1 is a perspective view showing a door lock according to an embodiment of the present invention mounted on a door and FIG. 2 is an exploded view of the door lock according to an embodiment of the present invention.

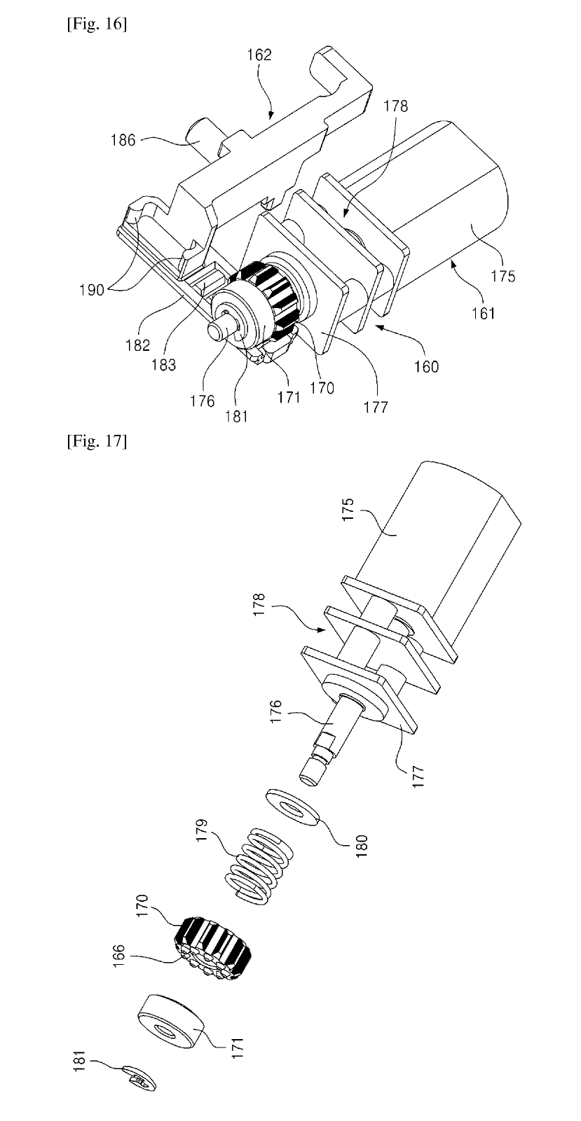

As shown in FIGS. 1 and 2, a door lock according to an embodiment of the present invention includes: a pair of door lock main bodies 101 combined with rotatable levers 103 and disposed on the interior side and the exterior side of a door; a door latch module 110 disposed between the pair of door lock main bodies 101, including a latch bolt 111 stretching and retracting to lock and unlock the door to and from a doorframe, and mounted on the door; a rotary connection module 115 connected with the levers 103, rotatably combined with the pair of door lock main bodies 101 to transmit a rotation force of the levers 103 to the door latch module 110, and keeping transmitting the rotation force to the door latch module 110 by stretching/contracting from/to the door lock main bodies 101 in accordance with the gap between the pair of door lock main bodies 101 that depends on the thickness of the door; a locking/unlocking module 160 (seen in FIG. 16 to be stated below) combined with the door lock main bodies 101 to stop/allow rotation of the rotary connection module 115 and preventing the door latch module 110 from being unlocked; and door lock couplers 250 capable of coupling the pair of door lock main bodies 101 to be spaced from each other in accordance with the thickness of the door.

According to this embodiment, the door lock main body 101 includes a door lock body 105 combined with the rotatable lever 103 and having a rotary coupling hole 187 at the position where the lever 103 is disposed, and a rotary housing 108 combined with the lever 103 and rotatably inserted in the rotary coupling hole 187 of the door lock body 105.

The door latch module 110 includes the latch bolt 111 that is disposed inside the pair of door lock main bodies 101 and is stretched out of a seat hole 113 of a latch body unit 112 to be inserted into a doorframe and retracted into the seat hole 113 by a rotation force of the rotary connection module 115 to lock a door to a doorframe (not shown), and in contrast, unlock the door from a doorframe (not shown) by a key (not shown) and an authentication unit 195.

The rotary connection module 115 is a medium capable of transmitting the rotation force of the lever 103 to the door latch module 110 by connecting the lever and the door latch module 110.

When the door lock main bodies 101 are mounted on a door, they are spaced from each other in accordance with the thickness of the door, in which the rotary connection modules 115 keep connecting the door latch module 110 and the rotary housing 108 combined with the lever 103, so they can transmit a rotation force to the door latch module 110 from the levers 103.

The locking/unlocking module 160 can keep a door locked or unlocked in cooperation with a mechanical key and the authentication unit 195 through which number can be digitally input, and the detailed description will be described below, following the rotary connection module 115.

First, the rotary connection module 115 according to an embodiment of the present invention is described.

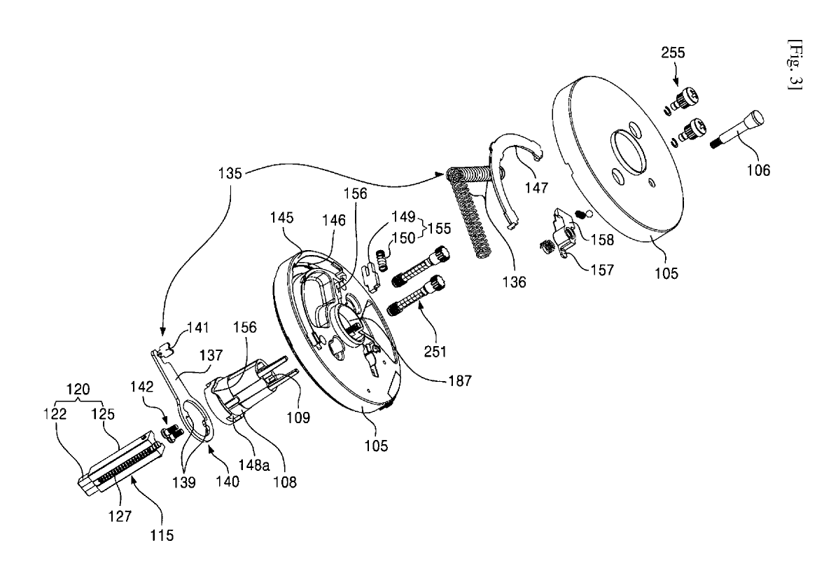

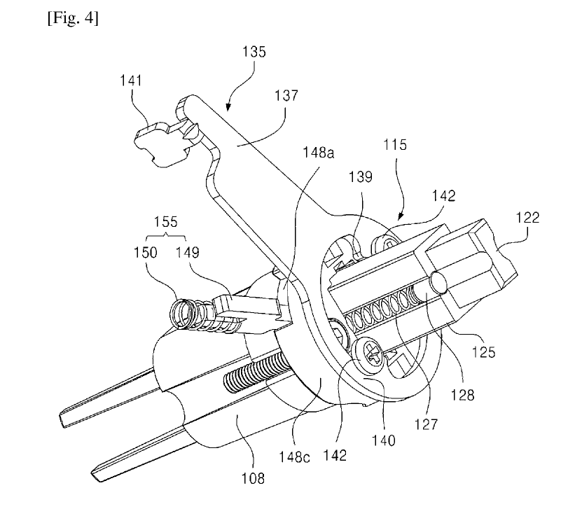

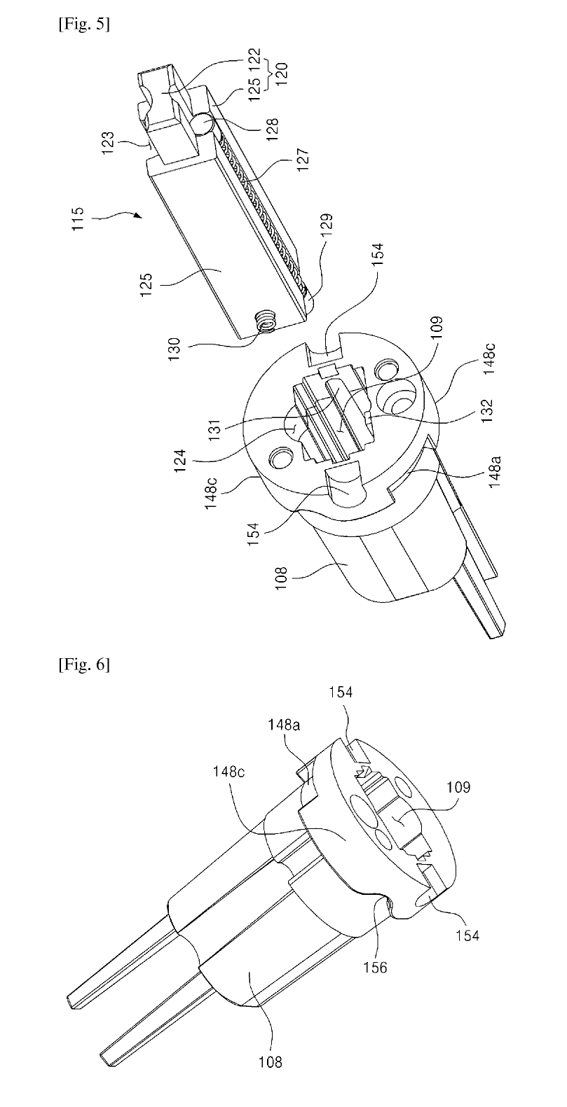

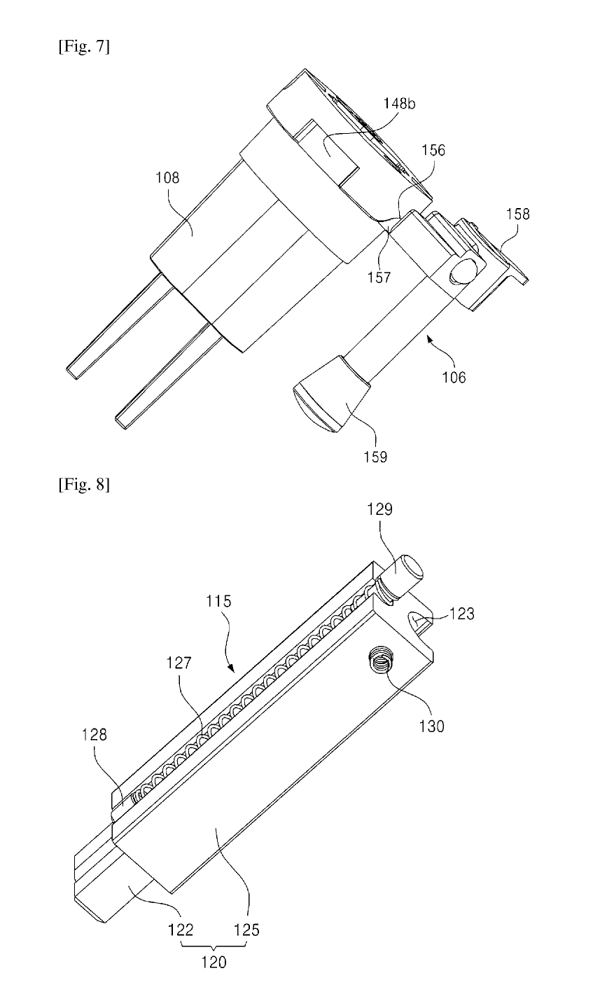

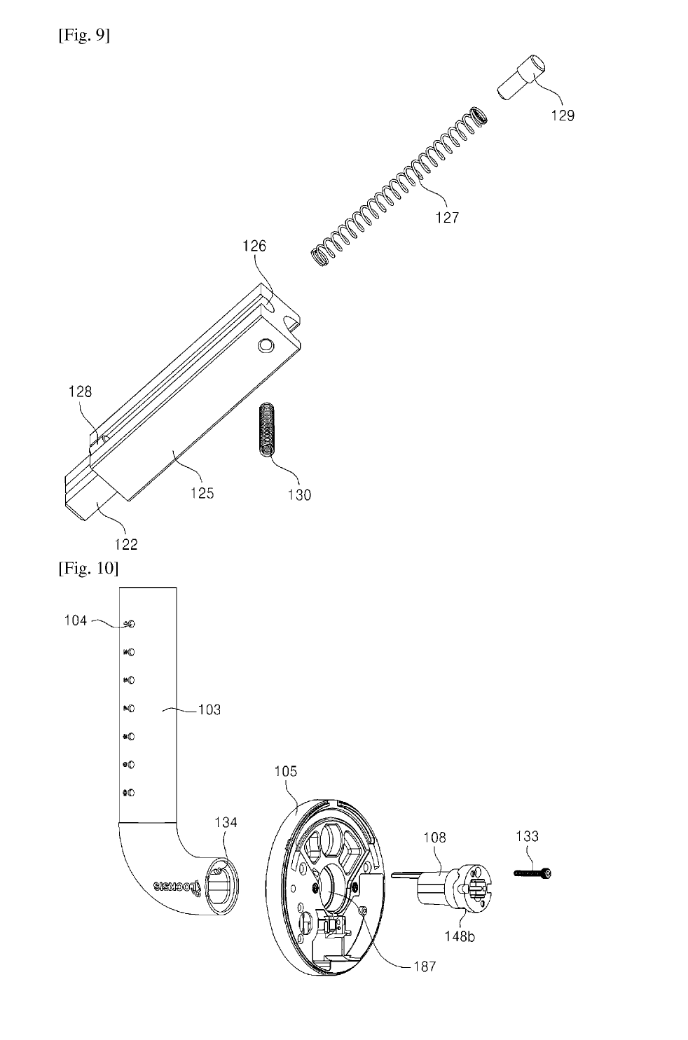

FIG. 3 is an exploded view showing a rotary connection module separated from a door lock main bodies shown in FIG. 2, FIG. 4 is a perspective view of an assembly of a rotary housing and the rotary connection module shown in FIG. 3, FIG. 5 is an exploded views showing the rotary housing and the rotary connection module shown in FIG. 4, FIG. 6 is a perspective view of the rotary housing shown in FIG. 5, FIG. 7 is a perspective view of a locking stopper combined with the rotary housing shown in FIG. 5, FIG. 8 is a perspective view of the rotary connection module shown in FIG. 5, and FIG. 9 is an exploded view of the rotary connection module shown in FIG. 8.

Referring to FIGS. 2 and 3, according to this embodiment, the rotary connection module includes a rotation transmission unit 120 that is combined with the rotary housings 108 rotatably combined with the left and right door lock bodies 105, is elastically supported by the rotary housings 108, and transmits a rotation force to the door latch module 110 by stretching to the door latch module 110 from the rotary housings 108. The rotary housings 108 connect the rotation transmission unit 120 and the levers 103 so that they can rotate together, and a slide passage 109 is formed to that the rotation transmission unit 120 can be elastically movably inserted therein.

Referring to FIGS. 3 to 9, the rotation transmission unit 120 may include a rotation transmission portion 122 connected to the door latch module 110, a rotary portion 125 connected to the rotation transmission portion 122, inserted in the slide passage 109 of the rotary housing 108, and having a spring passage 126, and a pressing spring 127 disposed in the spring passage 126 and supporting the rotary portion 125 in the rotary housing 108.

When the rotation transmission unit 122 connect the rotary housing 108 and the door latch module 110, the rotary portion 125 is inserted in the rotary housing 108, with one end supported by the pressing spring 127 supported in the rotary housing 108, and the rotation transmission portion 122 connected to the other end of the rotary portion 125 is inserted in a rotation input portion of the door latch module 110 by a supporting force of the pressing spring 127.

To this end, the rotation transmission unit 120 may further include a spring stopper 128 coupled to an end of the rotary portion 125 having the spring passage 126 and supporting the pressing spring 127, and a spring guide 129 inserted in the other end of the rotary portion 125 having the spring passage 126 and supported in the rotary housing 108.

The spring stopper 128 is fixed in the spring passage 126 and supports one end of the pressing spring 127. In contrast, the spring guide 129, which movably supports the rotary part 125 to the rotary housing 108 while moving along the spring passage 126, can support the pressing spring 127 to the rotary housing 108 when the rotary portion 125 moves along the slide passage 109 of the rotary housing 108.

Substantially, as the rotary portion 125 moves with respect to the rotary housing 108, the spring stopper 128 moves with the rotary portion 125, and the spring guide 129 is supported on a locking portion 132 of the rotary housing 108 and its position is fixed.

Further, rotation transmission unit 120 may further include a fitting elastic member 130 combined with the rotary portion 125 across the spring passage 126 and supported on the inner wall of the rotary housing 108 having the slide passage 109.

The fitting elastic member 130, which is a coil spring, can be supported and moved in an elastic member passage 131 formed on the inner wall of the rotary housing 108, when the rotary portion 125 is inserted into the slide passage 109 of the rotary housing 108.

Further, on the rotary portion 125 of the rotation transmission unit 120 and the inner wall with the slide passage 109 of the rotary housing 108, wire passage grooves 123 and 124 may be formed to face each other. The wire passage grooves 123 and 124 may be formed substantially in a circular shape so that a wire (not shown) passing between the rotary housing 108 and the rotation transmission unit 120 is disposed and not interfered with other parts around when the rotary portion 125 is moved.

As described above, the rotary connection module 115 can transmit a rotation force from the lever 103 to the door latch module 110 by connecting the lever 103 and the door latch module 110 by means of the rotation transmission unit 120. Further, even if the gap between the door lock bodies 105 increases in accordance with the thickness of a door, it can be kept in contact with the door latch module 110 to keep supported in the rotary housing and transmit the rotation force.

According to an embodiment of the present invention, the rotary connection module 115 is configured such that the rotary portion 125 of the rotation transmission unit 120 is elastically supported by the spring force and the rotation transmission portion 122 is connected to the door latch module 110, but the scope of the present invention is not limited thereto, and the rotation transmission portion 122 may be connected to the door latch module 110 by a combination of a motor 175 and a lead screw, or in a way of using an electronic power such as solenoid, or in a way of using only a bolt or a lead screw.

Referring to FIGS. 1, 3, and 7, a door lock assembly 106 that can be pressed at the outside is combined with the door lock body 105. The door lock assembly 106 is disposed on an interior door so that an external input unit (which may be a key input unit) of a door for opening the door in the interior can be locked. The door lock assembly 106 may include locking member 157 that can be locked in a locking groove 156 of the rotary housing 108 to lock a door, a moving member 158 combined with the locking member 157 and moving the locking member 157, and a press pin 159 combined with the moving member 158 and exposed outside from the door lock body 105 to provide a pressing force to the moving member 158. When the press pin 159 is pressed, a wing-shaped member (not shown) at a side of the door locking rod 106 operates an electric PCB switch (not shown), so it make an external input key (not shown) not work. In contrast, when the press pin 159 is pulled out or the interior lever 103 is rotated, the locking member 157 of the door lock assembly 106 is turned by the rotary housing 108 in the shape of a semicircle formed by the locking groove 156 and the moving member 158 is retracted, so that the PCB switch is inactivated and the external input unit (not shown) can be unlocked.

Referring to FIGS. 3 and 6, when a door is closed, in order to prevent unlocking of the door by mechanically preventing rotation of the lever 103, the rotary housing may have a plurality of stopper grooves 154, in which a stopper (not shown and described in relation with the locking/unlocking module 160) of a mechanical or electronic locking device is inserted and locked, to prevent rotation of the housing 108.

The stopper grooves 154 may be formed in various shapes on the outer side of the rotary housing 108, in which a mechanical stopper (not shown) by a key is inserted in one of the grooves and a stopper (not shown) of an electronic locking device is inserted not to rotate in the other one. The stoppers may be a clutch pin 186 of the locking/unlocking module 160 to be described below.

The reason that two stopper grooves 154 are provided is for preparing for a case when the left-handed and right-handed levers 103 may be changed due to opposite operation direction according to installation of a door, that is, the levers 103 may be selected for the left hand or the right hand, so two stopper grooves 154 corresponding to the case are formed on the rotary housing 108.

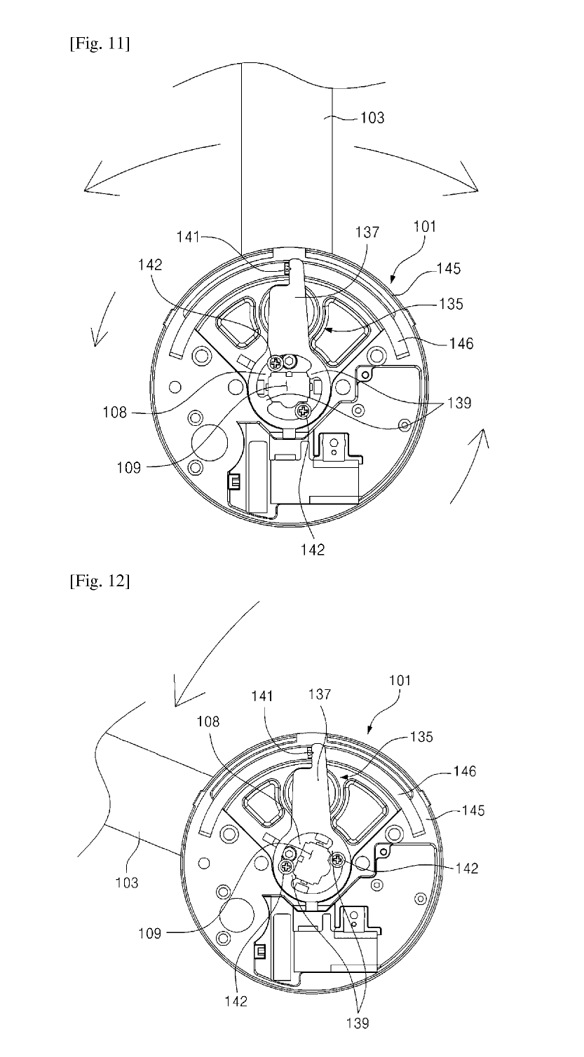

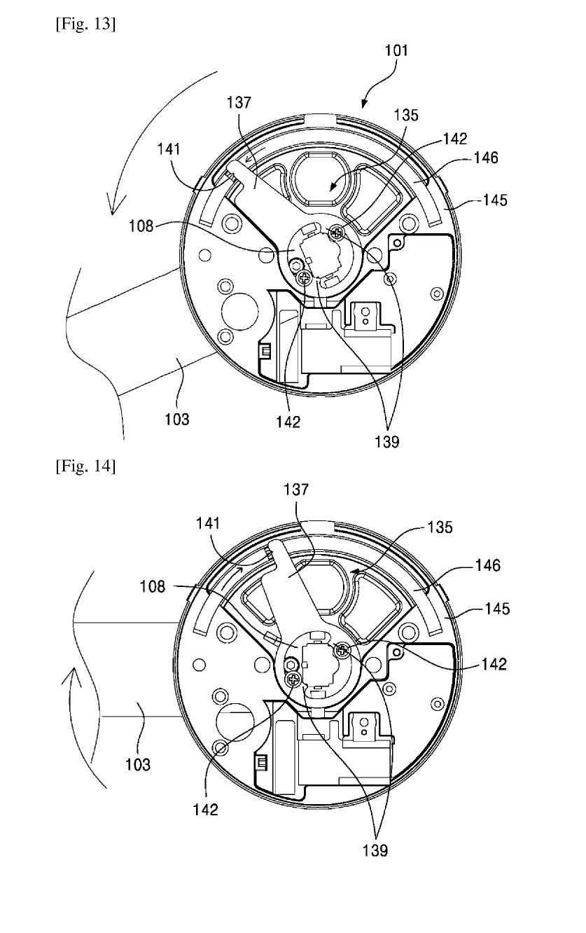

FIG. 10 is an exploded view showing the combination relationship between the rotary housing and the lever shown in FIG. 1, FIG. 11 is a front view showing a rotary return unit with a door lock main body separated and the lever of FIG. 1 in a neutral position, FIG. 12 is a front view showing rotation of the lever shown in FIG. 11, FIG. 13 is a front view showing rotation of a rotary plate of the rotary return unit by the rotary housing that rotates with the lever shown in FIG. 12, and FIG. 14 is a front view showing returning of the lever by the rotary return unit shown in FIG. 13.

Referring to FIG. 10, the lever 103 is fastened to the rotary housing 108 so that it can transmit a rotation force by tightening a bolt 133 in a fastening hole 134 through the rotary housing 108.

Referring to FIGS. 2 to 8 and FIG. 11, the lever 103 to be mounted on the door lock main body 101 may be selectively used as a left-handed lever rotating the rotary connection module 115 by rotating clockwise and a right-handed lever rotating the rotary connection module 115 by rotating counterclockwise. Selecting the left-handed lever and the right-handed lever is for selectively installing them in accordance with the rotation directions of the levers 103 because when the position where the door lock main body 101 is installed is changed, the suitable rotation direction of the levers 103 is changed.

To this end, the rotary housing 108 mounted on the door lock body 105 has a left-handed lever section 148a for transmitting clockwise rotation force of the lever 103 to the rotary connection module 110 and a right-handed section 148a for transmitting counterclockwise rotation of the lever 103 to the rotary connection module 110.

Further, a section moving portion 155 is disposed at a side of the rotary housing 106 to be able to move to any one of the left-handed lever section 148a and the right-handed lever section 148b of the rotary housing 108. The section moving portion 155 can move to any one of the left-handed lever section 148a and the right-handed lever section 148b and move within the section.

The left-handed lever section 148a and the right-handed lever section 148b are formed in the shape of a groove circumferentially on the outer side of the rotary housing 108, and a neutral section 148c through which the section moving portion 155 can move to the left-handed lever section 148a and the right-handed lever section 148b is provided between the left-handed lever section 148a and the right-handed lever section 148b. The neutral section 148c may be formed in a smooth slide curved surface.

Further, on the door lock body 105 of the door lock main body 101, a rotary coupling hole 187 in which the lever 103 and the rotary housing 108 are rotatably inserted is formed and a locking portion groove 156 in which the section moving portion 155 is disposed and that communicates with the rotary coupling hole 187 may be formed.

The section moving portion 155 may include a rotation-setting support 149 disposed in the locking portion groove 156 and protruding into the rotary coupling hole 187 and a rotation-setting spring 150 disposed in the locking portion groove 156 and supporting the rotation-setting support 149 to the inner wall of the door lock body 105.

When the lever 108 and the rotary housing 108 are combined, with the lever 103 selected as a left-handed lever or a right-handed lever, the movement range of the rotation-setting support 149 is determined to the left-handed lever section 148a and the right-handed lever section 148b, so the rotation range can be set.

That is, the rotation range is set on the rotary housing 108 combined with the lever 103, the lever 103 can rotate within a predetermined range of angle of the left-handed lever section 148a and the right-handed lever section 148b. The rotary housing 108 is locked to the left-handed lever section 148a and the right-handed lever section 148b so that the rotation-setting support 149 is elastically supported by the rotation-setting spring 150 and cannot move over the left-handed lever section 148a and the right-handed lever section 148b.

As described above, the lever 103 can transmit a rotation force to the door latch module 110 by means of the rotary housing 108 and the rotary connection module 115 so that a door opens, in which the lever 103 needs to be designed to return to the initial position, when the rotation force applied to the lever 103 is removed with a door fully open.

To this end, the door lock main body 101 may include a rotary return unit 135 that is combined with the rotary housing 108 and returns the lever 103 to the initial position within the left-handed lever section 148a and the right-handed lever section 148b.

The rotary return unit 135 may include a pair of springs 136 that is disposed circumferentially on the outer side of the door lock body 105 and supports the lever 103 to return it, corresponding to the left-handed lever section 148a and the right-handed lever section 148b. When the lever 103 is rotated to open a door, the rotary return unit 135 is combined with the rotary housing 108 such that it rotates with the rotary housing 108 combined with the rotary connection module 115.

Idling of the rotary housing 108 is allowed only when left-handed and right-handed types are set, and the idling is prevented after setting of the lever 103 is finished. Further, FIG. 11 shows installation of the lever 103 selectively in the left-handed type or the right-handed type, FIGS. 12 and 14 show the state in which the lever 103 finishes being set by rotating the lever 103 in one direction, FIG. 13 shows the state in which the lever has been rotated, and FIG. 14 shows the state in which the lever is returned.

That is, the rotary return unit 135 may include a rotary plate 140 that has a rotary locking protrusion 139 locked to a locking bolt 142 tightened in the rotary housing 108 and is combined with the rotary housing 108, a rotary return arm 137 that is connected to the rotary plate 140 and extending to the outer side of the door lock body 105, and a spring locking plate 141 that extends to the outer side of the door lock body 104, is combined with the rotary return arm 137, and is supported between the rotary return springs 136.

Further, the door lock main body 101 may further include: a return path provider 145 that is combined with the door lock body 105, is spaced from the rotational center of the rotary return arm 137 so that the rotary return springs 136 are disposed circumferentially, and forms a spring return passage 146 along the rotation path of the spring locking plate 141; and a spring cover 147 that is combined with the door lock body 105 and prevents the rotary return spring 136 from separating from the spring return passage 146.

Referring to FIGS. 3, 13, and 14, as the lever 103 of the door lock main body 101 is rotated to open a rood, the rotary housing 108 combined with the lever 103 is rotated at a predetermined angle, and as the rotary housing 108 is rotated, the locking bolt 142 presses the rotary locking protrusion 139, the rotary return ram 137 is rotated with the rotary housing 108, and the spring locking plate 141 combined with the rotary return ram 137 moves and presses any one of the pair of rotary return springs 136, such that the spring locking plate 141 is elastically supported. Thereafter, when the rotation force applied to the lever 103 is removed, the spring locking plate 141 is rotated in the opposite direction by an elastic force, the locking bolt 142 is pressed by the rotary locking protrusion 139, and the rotary housing 108 is rotated in the opposite direction, so that the lever 103 can be rotated and returned to the initial position.

According to this embodiment, as described above, since the door lock main body 101 has the rotary return unit 135, as a door opens, the lever 103 rotated in any one direction can be return to the initial position by the rotary return unit 135.

Further, since the rotary return unit 135 connected with the interior and exterior levers 103 uses the rotary return springs 136 mounted on the interior door lock main body 101 and the exterior door lock main body 101, the rotary return springs 136 are prevented from being damaged due to the repeated rotation forces by the levers 103, so it is possible to prevent the problem that the levers 103 fail to return.

Hereinafter, the locking/unlocking module 160 according to an embodiment of the present invention is described in detail.

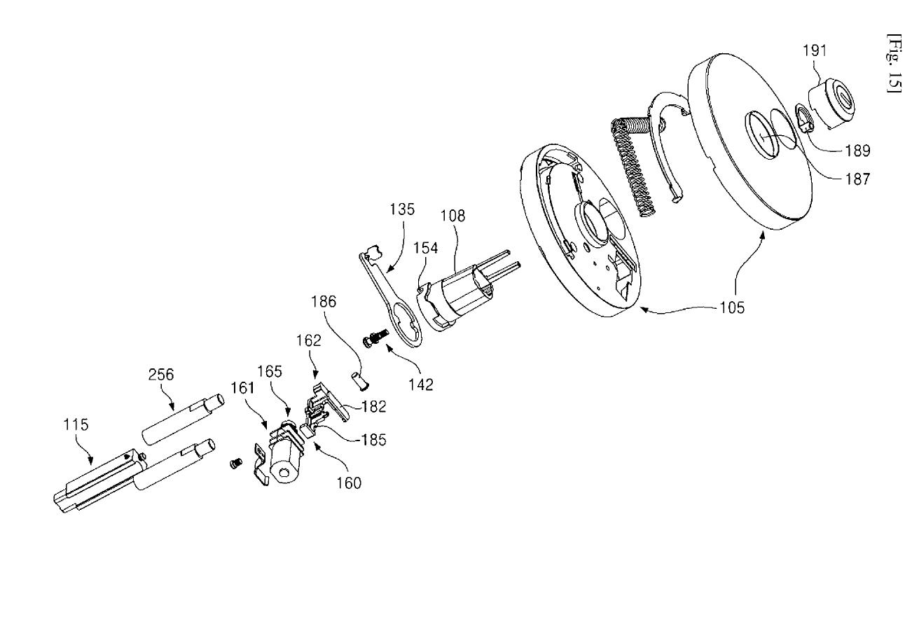

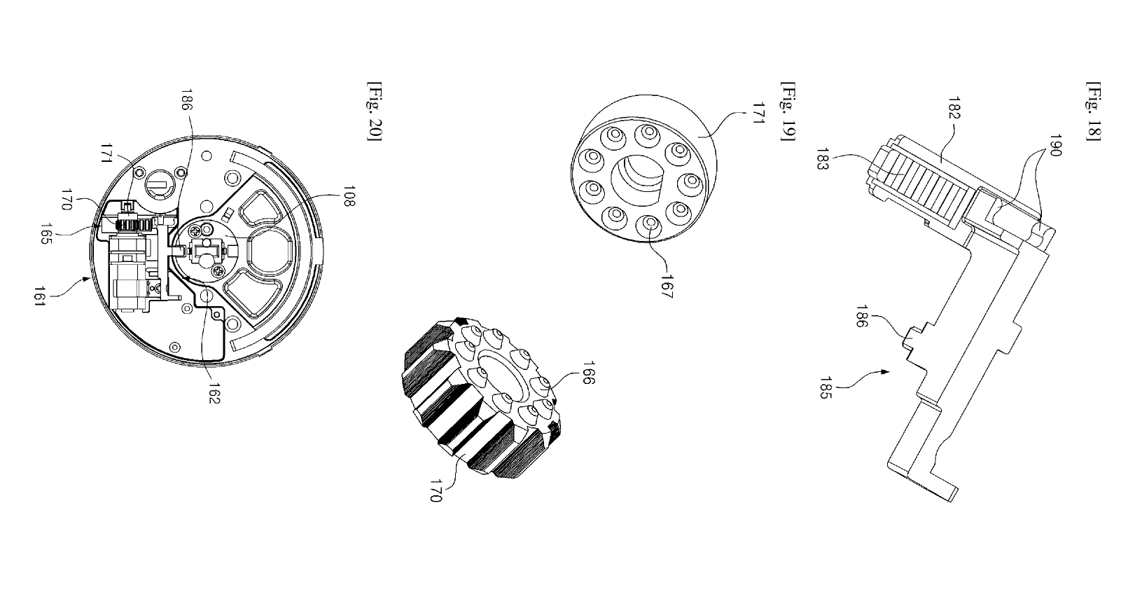

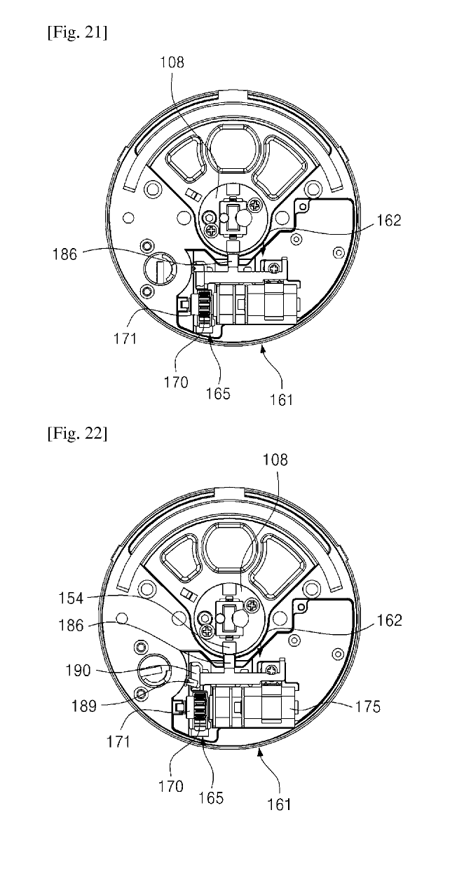

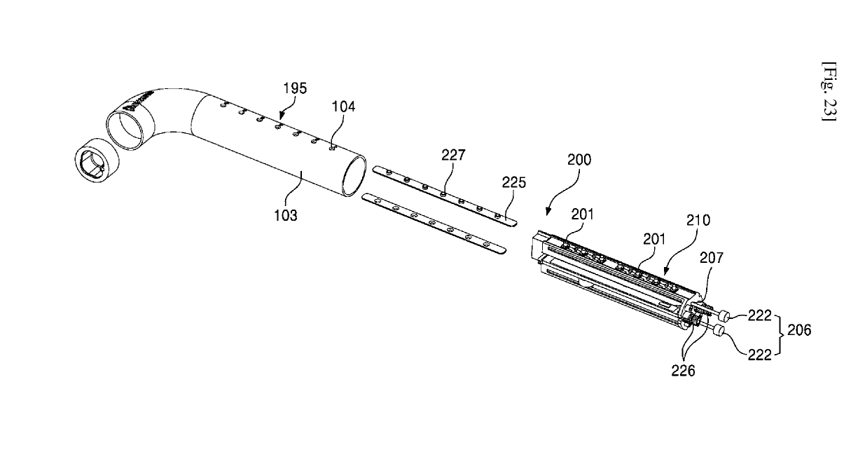

FIG. 15 is an exploded view showing locking/unlocking module of the door lock according to an embodiment of the present invention, FIG. 16 is a perspective view of the locking/unlocking module of FIG. 15, FIG. 17 is an exploded view showing a slip gear unit separated from a driving unit of the locking/unlocking module of FIG. 16, FIG. 18 is a top perspective view of a clutch unit of the locking/unlocking module of FIG. 16, FIG. 19 is an exploded perspective view showing a slip gear and a gear mount of the slip gear unit of the locking/unlocking module of FIG. 16, FIG. 20 is a front view showing a clutch pin of the locking/unlocking module of FIG. 16 inserted in the rotary housing, FIG. 21 is a front view showing the clutch pin of the locking/unlocking module of FIG. 20 separated from the rotary housing, and FIG. 22 is a front view showing the clutch pin separated from the rotary housing by pressing a cam guide of the clutch unit with a locking cam of FIG. 15.

As shown in FIGS. 1, and 15 to 22, the locking/unlocking module 160 includes a driving unit 161 disposed on the door lock main body 101, a clutch unit 162 disposed on the door lock main body 101 and operated by the driving unit 161 to prevent and allow rotation of the rotary connection module 115, and a slip gear unit 165 is disposed on a rotary shaft 176 of the driving unit 161 and idling in accordance with transmission torque to connect/disconnect between the driving unit 161 and the clutch unit 162.

The locking/unlocking module 160 is disposed on the door lock main body 101 to keep a door closed by preventing rotation of the rotary connection module 115, when the door is closed, and it can keep the door closed, mainly using the function of preventing the rotary housing 108 combined with the rotary connection module 115 from rotating due to the lever 103.

Further, the clutch unit 162 can prevent rotation of the rotary housing 108 by locking the rotary housing 108, when it is operated by a mechanical key. When the clutch unit 162 is operated by a mechanical key, the slip gear unit 165 prevents transmission of a rotation force from the clutch unit 162 to the driving unit 161 by idling, so it can prevent unnecessary wear of various driving components that may be included in the driving unit 161.

To this end, the slip gear unit 165 may have the a plurality of slip protrusions 166 that is spaced from each other by transmission torque of any one of the clutch unit 162 and the driving unit 161 and disposed circumferentially to connect/disconnect torque transmission, and slip protrusion seat grooves 1667 corresponding to the slip protrusions 166. The slip protrusions 166 and the slip protrusion seat grooves 167 may have inclined surfaces 168 so that they can be easily separated from each other.

That is, the slip gear unit 165 can transmit a rotation force between the driving unit 161 and the clutch unit 162, using the combination of the slip protrusions 166 and the slip protrusion seat grooves 167 for inserting the slip protrusions 166, and when the transmitted torque increases, the slip protrusions 166 and the slip protrusion seat grooves 167 are separated, thereby stopping transmission of the rotation force.

For this idling, the slip gear unit 165 includes: a slip gear that is engaged with the clutch unit 162, elastically supported to be movable along the rotary shaft 176, rotatably combined with the rotary shaft 176, and has any one of the slip protrusions 166 and the slip protrusion seat grooves 167; and a gear mount 171 that is combined with the rotary shaft 176 to be rotatable with the rotary shaft 176, is in contact with the slip gear 170 by an elastic force applied to the slip gear 170, and has the other of the slip protrusions 166 and the slip protrusion seat grooves 167.

According to this embodiment, the slip gear 170 has the slip protrusions 166 and the gear mount 171 has the slip protrusion seat grooves 167. The scope of the present invention is not limited to the arrangement and shape of the slip protrusions 166 and the slip protrusion seat grooves 167, and the positions may be changed and formed in a rounded shape with little inclination.

Further, the driving unit 161 for driving the clutch unit 162 may include a motor 175 driving the rotary shaft 176, a support plate 177 disposed on the rotary shaft 176 and supporting the slip gear 170, and a reducer 178 engaged with the rotary shaft 176 and the motor 175.

When an electric signal saying operation of a locking button or an unlocking button is input by a button unit 220 of the lever 103, the driving unit 161 is driven in any one direction in response to the signal. The reducer 178 can increase torque transmitted to the clutch unit 162 by reducing the rotation ratio from the driving shaft to the rotary shaft 176 of the motor 175. The reducer 178 is disposed between the supporting plate 177 and the motor 175 and schematic arrangement without gears shown in detail is provided in this embodiment.

The slip gear unit 165 for transmitting torque between the driving unit 161 and the clutch unit 162 may further include a gear support spring 179 disposed on the rotary shaft 176 to be supported on the support plate 177 and supporting the slip gear 170, a slip washer 180 disposed on the rotary shaft 176 to support the gear support spring 179, on the supporting plate 177, and a stop ring 181 combined with the rotary shaft 176 and fixing the gear mount 171.

Substantially, the slip gear 170 is disposed on the rotary shaft 176 to be able to slide between the gear mount 171 and the gear support spring 179 along the rotary shaft 176, and the gear support spring 179 fits the slip protrusions 166 into the slip protrusion seat grooves 167 by pressing the slip gear 170 to the gear mount 171.

When the transmission torque between the slip gear 170 and the gear mount 171 rotating with the rotary shaft 176 increases, the slip gear 170 moves while compressing the gear support spring 179. When the transmission torque decreases, the slip gear 170 is moved to the gear mount 171 by the returning force of the gear support spring 179 and the slip protrusions 166 of the slip gear 170 are fitted into the slip gear seat grooves 167.

The slip washer 180 functions as a bearing so that the gear support spring 179 can easily rotate on the supporting plate 177, by supporting the gear support spring 179 idling in contact with the slip gear 170.

The clutch unit 162 receiving a rotation force from the slip gear unit 165 includes a rack gear portion 182 having a rack gear 183 to be engaged and operated with the slip gear unit 165, and a clutch portion 185 combined and moved with the rack gear portion 182 and having a clutch pin 186 connecting/disconnecting rotation of the rotary connection module 115.

According to this embodiment, when the slip gear 170 is engaged with the rack gear portion 182 and moves the rack gear portion 182, the clutch pin 186 of the clutch portion 182 moves to the rotary housing 108 together with the rack gear portion 182 to connect/disconnect rotation of the rotary connection module 115 and is inserted into the stopper groove 154. The rack gear portion 182 is movably disposed on the door lock main body 101 and the clutch portion 185 can be combined with the rack gear portion 182 and moved with the rack gear portion 182.

The case when the clutch portion 185 is moved and the slip gear 170 is rotated by the rack gear portion 170, due to torque transmission by a mechanical key means that the resistant torque of the reducer 178 connected with the slip gear 170 is smaller than the transmission torque of the slip gear 170, so as the transmission torque increases, the slip protrusions 166 of the slip gear 170 are separated from the slip protrusion seat grooves 167 of the gear mount 171, and accordingly, the driving unit 161 is protected from wear and shock due to an external rotation force.

Further, as described above, the door lock main body 101 receiving an external rotation torque by a key may include the door lock body 105 combined with the rotatable lever 103, having a rotary coupling hole 187 at the position where the lever 103 is disposed, and combined with the clutch unit 162, and a locking cam 189 disposed on the door lock body 105 and included in a locking assembly 191 to move the clutch portion 185 in cooperation with a key.

The clutch portion 185 includes a cam guide 190 pressed in contact with the locking cam 189 and the cam guide 190 may be formed in the shape of a panel combined with the rack gear portion 182 so that it can move the rack gear portion 182.

Though described above, the door lock main body 101 has the rotary housing 108 having a stopper groove 154 in which the clutch pin 186 is inserted and locked. The rotary housing 108 is combined with the lever 103 and rotatably combined in the rotary coupling hole 187 of the door lock body 105 so that the rotary connection module 115 is rotated by the lever 103.

Further, the lever 103 may include an authentication unit 195 for operating the driving unit 161 and an inclination sensor 196 that generates a signal for operating the driving unit by sensing the rotation angle of the lever 103 when the lever 103 is rotated. That is, the driving unit 161 can perform unlocking, when number for unlocking are input in the authentication unit 195. Further, the driving unit 161 can lock a door by operating after the lever 103 is rotated and the rotation of the lever 103 is sensed by the inclination sensor 196.

Hereinafter, an operation button module 200 providing the authentication unit 195 disposed on the lever 103 to operate the locking/unlocking module 160 of the door lock according to an embodiment of the present invention will be described in detail.

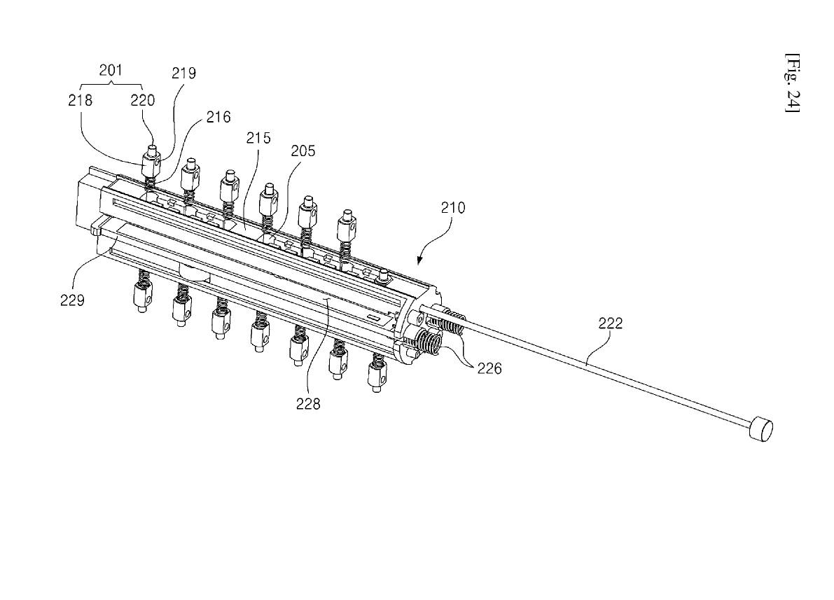

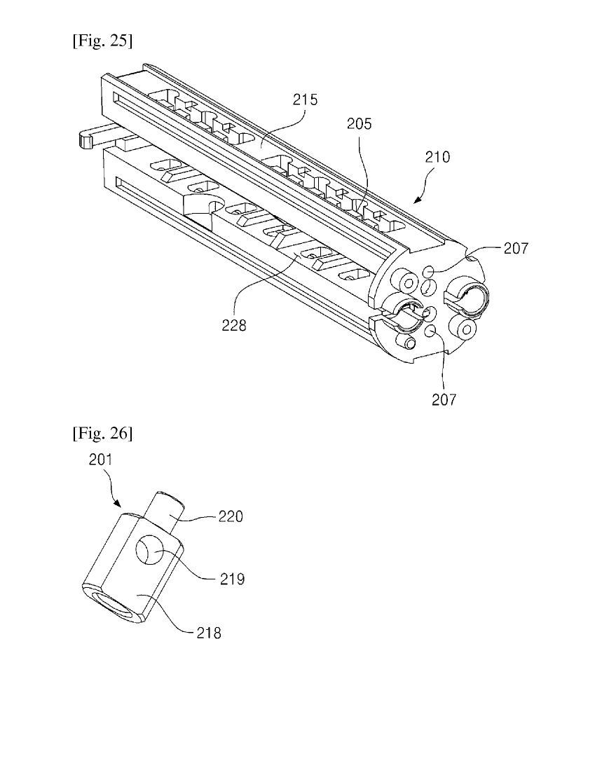

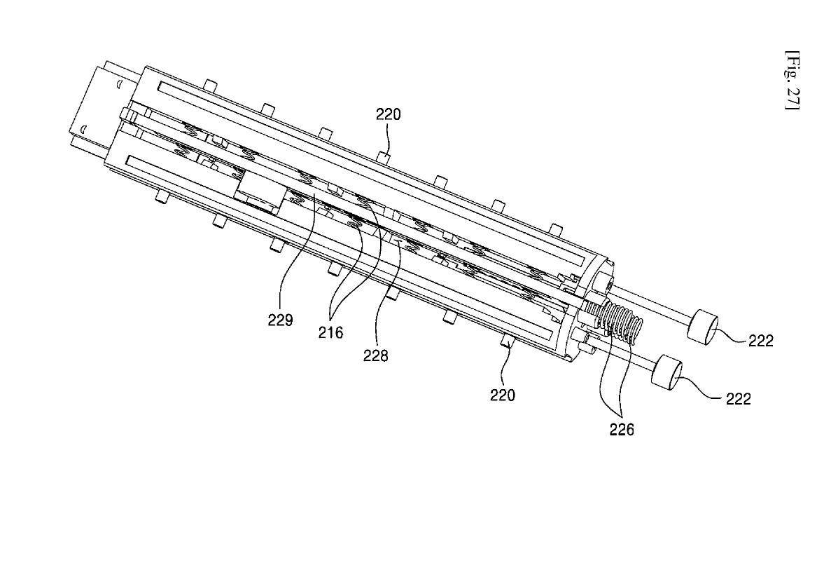

FIG. 23 is an exploded view showing an operation button module separated from the lever of FIG. 1, FIG. 24 is a perspective view showing a coupling tool combined with the operation button module of FIG. 23, FIG. 25 is a perspective view showing an operation button body of the operation button module of FIG. 23, FIG. 26 is a perspective view showing an authentication button of the operation button module of FIG. 23, FIG. 27 is a bottom perspective view showing the coupling tool combined with the operation button module of FIG. 23.

Referring to FIGS. 1 and 2 and FIGS. 23 to 27, the operation button module 200 has a plurality of coupling holes 205 arranged in a line for installing a plurality of authentication buttons 201, and coupling passages 207 to which coupling tools 206 are separably coupled to fix the authentication buttons 201 in the coupling holes 201. When the operation button module 20o is inserted in the lever 103, the authentication buttons 201 protrude through holes 104 formed in advance in the lever 103. The operation module 200 includes: an operation button body 210 that includes button bases 215 that are disposed inside the lever 103, in which the coupling holes 205 are spaced from each other in a line, and in which the coupling passages 207 cross the coupling holes 205; and elastic members 216 that are disposed in the coupling holes 205 of the button bases 215 and elastically support the authentication buttons 201.

The coupling tools 206 prevent the authentication buttons 201 from separating from the operation button body 210 by retaining the authentication buttons 201 in the coupling holes 205, when the authentication buttons 201 are assembled with the operation button body 210 and fitted in the lever 103. When the operation button body 210 is placed inside the lever 103, the authentication buttons 201 inserted in the coupling holes 205 protrude outside through the holes 104 of the lever 103. The coupling tools 206 can contribute to assembling by preventing the authentication buttons 201 from inclining and separating in the gravity direction or separating due to interference by the inner wall of the lever 103.

Further, the authentication buttons 201 include a button body 218 having a coupling through-hole 219 to communicate with the coupling passages 207 and inserted in the coupling hole 205, and a button portion 220 protruding on the button body 218.

The coupling tools 206 are inserted into the coupling through-holes 219, when the authentication buttons 201 are inserted into the coupling holes 205, and they may be coupling rods 222 that are separated, after the button bases 215 are disposed inside the lever 103 and the button portions 220 protrude outside through the lever 103.

That is, when the coupling rods 222 are inserted into the coupling passages 207 of the operation button body 210, they are inserted also into the coupling through-holes 219 of the button body 218, so they can prevent the authentication buttons 201 from separating from the coupling holes 205. As described above, the coupling rods 222 can pass the button bodies 218 arranged in a line through the coupling passages 207.

The button bodies 218 are inserted in the coupling holes 205 while pressing the button elastic members 216. The button bodies 218 can be returned and separated from the coupling holes 205 by the button elastic members 216, but they are fitted on the coupling rods 222 disposed through the coupling passages 207, so they are not separated.

The operation button module 200 further includes external rubber buttons 225 that are disposed in side the lever 103, protrude outside through the lever 103, in which the button portions 220 are inserted, and that prevent transmission of static electricity to the lever 103 from the button portions 220. The authentication buttons 201 use a touch sensor type, the external rubber buttons 225 prevent leakage of static electricity generated when a finger touches the authentication buttons 201, and the static electricity is transmitted to the button portions 220 so that individual signals can be generated by the operation of the button portions 220.

That is, when the authentication buttons 201 fixed by the coupling rods 222 of the operation button module 200 are mounted on the lever 103, the external rubber buttons 225 disconnect the button portions 220 from the lever 103 by covering the button portions 220, so leakage of static electricity to the lever 103 made of metal is prevented. Accordingly, the static electricity transmitted from a finger can be smoothly transmitted to a touch sensor unit (not shown) of a controller 229, which is described below, through the button portions 220.

The static electricity transmitted to the button portions 220 is transmitted to the touch sensor unit (not shown) through the button elastic members 216 having the shape of a coil spring supporting the button portions 220 and connected to the touch sensor unit (not shown). That is, one end of the button elastic member 216 is connected with the touch sensor unit (not shown) including a touch sensing circuit and the other end is connected to the button portion 220, so that the button elastic member 216 transmits the static electricity input from the button portion 220 to the touch sensor unit (not shown) of a circuit.

The operation button module 200 further include operation button body support springs 226 that are inserted in the operation button bodies 218 to be supported on the inner wall of the lever 103, when the operation button bodies 218 are mounted on the lever 103. That is, the operation button body support springs 226 are supported on the cover 230 of the lever 103, when the operation button body 210 is disposed inside the lever 103, so they can fix the operation button body 210 without movement inside the lever 103.

The operation button body 210 has a pair of button bases 215 spaced from each other such that the authentication buttons 210 are disposed over and under the lever 103. That is, the button bases 215 are provided at the upper and lower portions of the operation button body 210.

Further, the operation button module 200 further include the controller 229 that is disposed in a controller groove 228 between the pair of button bases 215 and unlocks a door by operating the locking/unlocking module 160 in response to a signal from the authentication buttons 201.

The controller 229 has a microcontroller in which passwords input and an unlocking routine capable of unlocking a door by combining input numbers of the authentication buttons 201 are programmatically provided.

According to this embodiment, the controller 229 includes a micom circuit for the microcontroller and is disposed inside the lever 103 and the lever 103 is made of steel, so it is possible to improve security and durability of the controller 229 and keep it safe against a fire.

The operation button module 200 includes the inclination sensor 196 generating a signal saying the rotation angle of the lever 103 to the controller 229 so that the rotation angle of the lever 103 is sensed, when the lever 103 is rotated, and accordingly, the rotation of the lever 103 is sensed by the inclination sensor 196 and the sensing signal is input to the microcontroller, so that the microcontroller can electrically activate the driving unit 161 of the locking/unlocking module 160.

Further, since the inclination sensor 196 is connected to the controller 229, the microcontroller of the controller 229 may have a built-in low-power operation program in order not to unnecessarily consume power by not operating when the lever 103 is not at a normal position when a door returns after opening, but operating only when the lever 103 is at the normal position.

Further, the inclination sensor 196 may make it possible to set the directions of light emission diodes (not shown) which are differently set in accordance with the left-handed/right-handed types of the levers 103, by making the controller 229 automatically recognize the rotation directions of the levers 103 inside and outside a door.

A method of assembling a door lock according to an embodiment of the present invention, including the process in which the operation button module 200 is combined with the lever 103 by the coupling rods 222, is as follows.

A method of assembling a door lock according to an embodiment of the present invention includes: installing door lock main bodies 101 combined with rotatable levers 103 on the interior side and the exterior side of a door; installing a door latch module 110, which includes a latch bolt 111 for locking/unlocking the door to/from a doorframe, on the door, between the door lock main bodies 101; installing a rotary connection module 115 to be rotatable on the door lock main bodies 101 in order to be connected with the levers 103 and transmit a rotation force of the levers 103 to the door latch module 110; installing a locking/unlocking module 160 on the door lock main bodies 101 to prevent and allow rotation of the rotary connection module 115; and installing an operation button module 200, which has a plurality of coupling holes 205 for installing a plurality of authentication buttons 201 and has coupling passages 207 for locking the authentication buttons 201 to the coupling holes 205, on the levers 103.

In detail, the installing of an operation button module 200 on the levers 103 according to this embodiment includes: inserting the authentication buttons 201 into the corresponding coupling holes 205; inserting coupling tools 206 into the coupling passages 207 to fix the authentication buttons 201 to the coupling holes 205; and separating the coupling tools 206, when the authentication buttons 201 protrude on the levers 103 by inserting the operation button module 200 inside the levers 103.

Further, the authentication buttons 201 include: button bodies 218 that having a coupling through-holes 219 aligned with the coupling passages 207 and are inserted in the coupling holes 205; and button portions 220 that protrude on the button bodies 218. Accordingly, the installing of an operation button module 200 may include: fitting the coupling tools 206 into the coupling through-holes 210, with the button bodies 218 inserted in the coupling holes 205; and separating the coupling tools 206, with the button portions 220 are disposed on the levers 103 to protrude outside through the levers 103. The operation module 200 includes: an operation button body 210 including button bases 215 that are arranged inside the levers 103, have the coupling holes 205 spaced from each other in a line, and have the coupling passages 207 across the coupling holes 205; and button elastic members 216 disposed on the operation button body 210 and elastically supporting the authentication buttons 210. Accordingly, the installing of an operation button module 200 further includes installing the button elastic members 216 to support the authentication buttons 201.

Further, the operation button module 200 further includes external rubber buttons 225 that is combined with the button portions 220 and prevents leakage of static electricity from a finger to the levers 103. Accordingly, the installing of an operation button module 200 may further include installing the external rubber buttons 225 inside the levers 103 to protrude outside through the levers 103.

That is, the external rubber buttons 225 are disposed inside the levers 103, button protrusions 227 on the external rubber buttons 225 are inserted in holes 104 of the levers 103.

Further, with the button protrusions 227 of the external rubber button 225 inserted in the holes 104 of the levers 103, the operation button bodies 210 are inserted inside the levers 103 and the button portions 220 are arranged to correspond to the button protrusions 227 of the external rubber buttons 225, and coupling rods 222 are separated from the operation button module 200, so that the button portions 220 are fitted in the button protrusions 227 of the external rubber buttons 225. The button portions 220 fitted in the external rubber buttons 225 are exposed to the outside through the holes 104 of the levers 103 to be pressed down by a finger.

The door lock coupler 250 that can combine the door lock main bodies 101 that are spaced from each other in accordance with the thickness of a door, in a door lock according to an embodiment of the present invention is described hereafter.

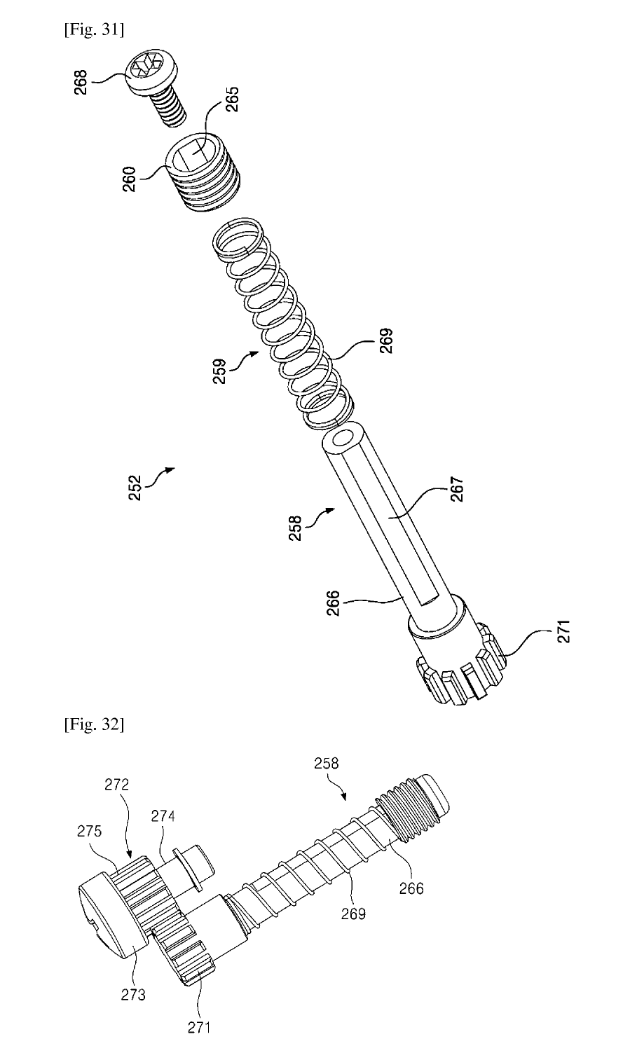

Referring to FIGS. 1 to 3 and FIGS. 28 to 32, the door lock fastening portion 250 combines the door lock main bodies 101 that are spaced from each other at a predetermined distance such that the distanced between the door lock main bodies 101 can be changed.

That is, the door lock fastening portion 250 includes door main body-variable combining members 251 that combines the door lock main bodies 101 and stretches/retracts in accordance with the thickness of a door, and door main body distance adjustment members 255 that is connected to the door main body-variable combining members 251 and adjusts the distance between the door lock main bodies 101.

The door lock main bodies 101 combined by the door main body-variable combining units 251 are disposed opposite each other at both sides of a door, and the distance between the door lock main bodies 101 can be adjusted to fit the thickness of a door by adjusting the door main body distance adjustment members 225 at the outside of the door lock main bodies 101.

The door main body-variable combining members 251 include a distance adjustment joint portion 256 that is combined with any one of the door lock main bodies 101 and has a movement passage 257 with a female screw (not shown) on the inner wall, and a fastening bolt 252 that is combined with the other one of the door lock main bodies 1011 and thread-fastened to the female screw (not shown) of the distance adjustment joint portion 256.

According to this embodiment, since the gap between the fastening bolts 252 can be reduced, installation can be performed regardless of not only when the thickness of a door is small, but the size of through-holes (not shown) of the fastening bolts is small with respect to a door, so the door lock main bodies 101 can be combined without increasing the through-holes (not shown) or additionally boring.

The distance adjustment joint portion 256 includes a female-threaded pipe 280 combined with the door lock main body 101, and a female-threaded holder 281 coupled to an end of the female-threaded pipe 280 and restricting separation of the female-threaded pipe 280 from a coupling portion of the door latch module 110 in which the female-threaded pipe 280 is inserted.

A ring-shaped groove 282 is formed at the end of the female-threaded pipe 280, and the female-threaded holder 281 includes a ring-shaped fixing plate 283 disposed around the ring-shaped groove 282, a holder plate spring 284 disposed at a predetermined range of the ring-shaped fixing plate 283, and a holder locking protrusion 285 formed at the holder plate spring 284 and restricting separation of the female-threaded pipe 280.

When the door lock main bodies 101 are combined by means of through-holes of a door at both sides of the door, the female-threaded pipes 280 of the distance adjustment joint portions 256 are inserted in the door latch module 110.

In this state, the holder locking protrusions 285 of the female-threaded holders 281 combined with the female-threaded pipes 280 are locked in the door latch module 110 and the door lock main bodies 101 are prevented from separating from the door latch module 110, so they can be combined without separating from the through-holes (not shown) of the door.

That is, according to this embodiment, when the interior and the exterior door lock main bodies 101 are fastened, the door lock main bodies 101 are prevented from moving backward, so the door lock main bodies 101 can be generally easily fastened.

The fastening bolt 252 include a distance adjustment shaft portion 258 movably inserted in the movement passage 257, and a distance adjustment elastic member 259 elastically supported when the distance adjustment joint portion 256 and the distance adjustment shaft portion 258 are combined by a moving bolt 260 to be described below.

The distance adjustment shaft portions 258 can be inserted and moved in the movement passages 257 of the distance adjustment joint portion 256, so when the distance adjustment joint portions 256 are coupled to a door lock main body 101 and the distance adjustment shaft portions 258 are coupled to the other door lock main body 101, both door lock main bodies 101 can be moved and fixed while pressing the distance adjustment elastic members 259, so the distance between the door lock main bodies can be adjusted in accordance with the thickness of a door.

The fastening bolt 252 of the door main body-variable combining unit 251 may further include the moving bolt 260 that has a slide passage 109 connected to the movement passage 257 of the distance adjustment joint portion 256 and is thread-fastened to the inner wall forming the movement passage 257 of the distance adjustment joint portion 256. The moving bolt 260 has a flat anti-rotation portion 265 on the inner wall forming the slide passage 109 to rotate with the distance adjustment shaft portion 258, and is supported on the distance adjustment shaft portion 258 by the distance adjustment elastic member 259.

That is, the distance adjustment shaft portion 258 is sliding-coupled to the movement bolt 260 to be rotatable with the movement bolt 260 and the movement bolt 260 is thread-fastened to the distance adjustment joint portion 256, so that as the distance adjustment shaft portion 258 is rotated, the movement bolt 260 moves along the distance adjustment joint portion 256.

Further, since the movement bolt 250 is positioned at the front end of the distance adjustment shaft portion 258 by the distance adjustment elastic member 259, as the movement bolt 260 is rotated, the distance adjustment shaft portion 258 is moved through the movement passage 257 of the distance adjustment joint portion 256, so that the distance between the door lock main bodies 101 is adjusted.

The distance adjustment shaft portion 258 may include a rotary shaft portion 266 having a flat rotary portion 267 corresponding to the anti-rotation portion 265 of the movement bolt 260, and a shaft bolt 268 coupled to the front end of the rotary shaft portion 266 to restrict separation of the rotary shaft portion 266 from the movement bolt 260.

The movement bolt 260 supported by the distance adjustment elastic member 259 is restricted to the rotary shaft portion 266 by the shaft bolt 268. In this state, the distance adjustment elastic member 259, which is a shaft support spring 269 having the shape of a coil spring, is disposed at the rotary shaft portion 266 so that the rotary shaft portion 266 is inserted, and is supported on the rotary shaft portion 266 and the movement bolt 260.

The door main body distance adjustment member 255 may include a first distance adjustment gear portion 271 coupled to the distance adjustment shaft portion 258 and rotating the distance adjustment shaft portion 258, and a second distance adjustment gear portion 272 engaged with the first distance adjustment gear portion 271 and rotatably coupled to any one of the door lock main bodies 101 to rotate the first distance adjustment gear portion 271.

The second distance adjustment gear portion 272 includes a gear head 273 rotatably exposed to the outside of the door lock main body 101, a gear head rotary shaft 274 connected to the gear head 273 and rotatably coupled to the door lock main body 101, and a pinion gear 275 disposed between the gear head 273 and the gear head rotary shaft 274 and engaged with the first distance adjustment gear portion 271.

Comparing the pinion gear 275 and the first distance adjustment gear portion 271, the pinion gear 275 has more teeth than the first distance adjustment gear portion 271, so the rotation angle of the first distance adjustment gear portion 271 according to the rotation angle of the second distance adjustment gear portion 272 is large, and accordingly, the movement bolt 260 can be moved long even at a small rotation angle.

According to this embodiment, the door main body distance adjustment member 255 rotates the gear head 273 of the second distance adjustment gear portion 272, and the first distance adjustment gear portion 271 is rotated and the distance adjustment shaft portion 258 is rotated with the first distance adjustment gear portion 271, when the pinion gear 275 is rotated with the gear head 273, so the movement bolt 260 moves in a bolt type in the movement passage 257 of the distance adjustment joint portion 256, and accordingly, the distance between the door lock main bodies 101 can be adjusted.

As described above, the door lock fastening portion 250 according to this embodiment moves the movement bolt 260, using the first distance adjustment gear portion 271 and the second distance adjustment gear portion 272, but the scope of the present invention is not limited thereto, it may be possible by directly rotating the first distance adjustment gear portion 271—for example, the first distance adjustment gear portion 271 has a head for a wrench.

The door latch module 110, the rotary connection module 115, the locking/unlocking module 160, the operation button module 200, the door lock fastening portion 250, and the fastening bolt 252 according to this embodiment can be applied to not only a digital door lock in which a latch bolt 111 and a dead bolt 111 are integrated in a single structure, but a mortise type of digital door lock in which a latch bolt 111, which is elastically supported on door lock main bodies 101 to fix a door to a doorframe, and a dead bolt (not shown), which protrudes from door lock bodies 101 to lock the door to the doorframe, are provided at the door lock main bodies 101, respectively.

Additionally, the rotary housing 108 and the rotary connection module 115 described above, which are connected to the door latch module 110 to transmit the rotation force of the lever 103 to the door latch module 110, may have a simpler structure.

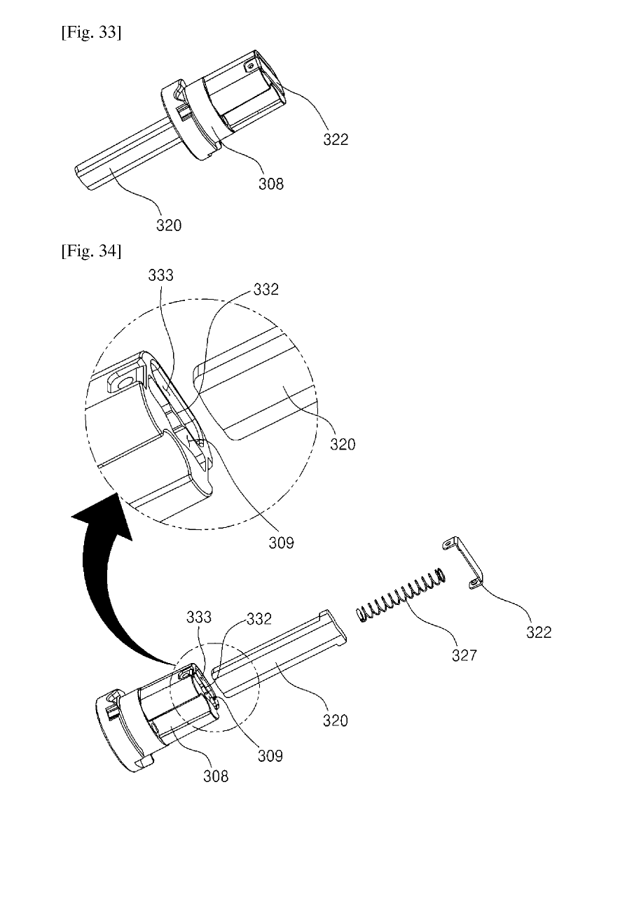

FIGS. 33 and 34 show another embodiment of the rotary housing 108 and the rotary connection module 115 described above.

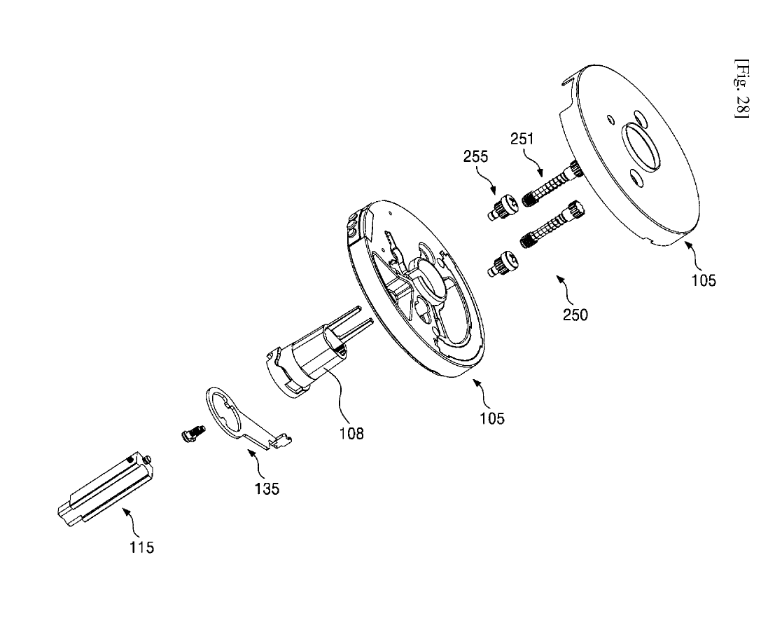

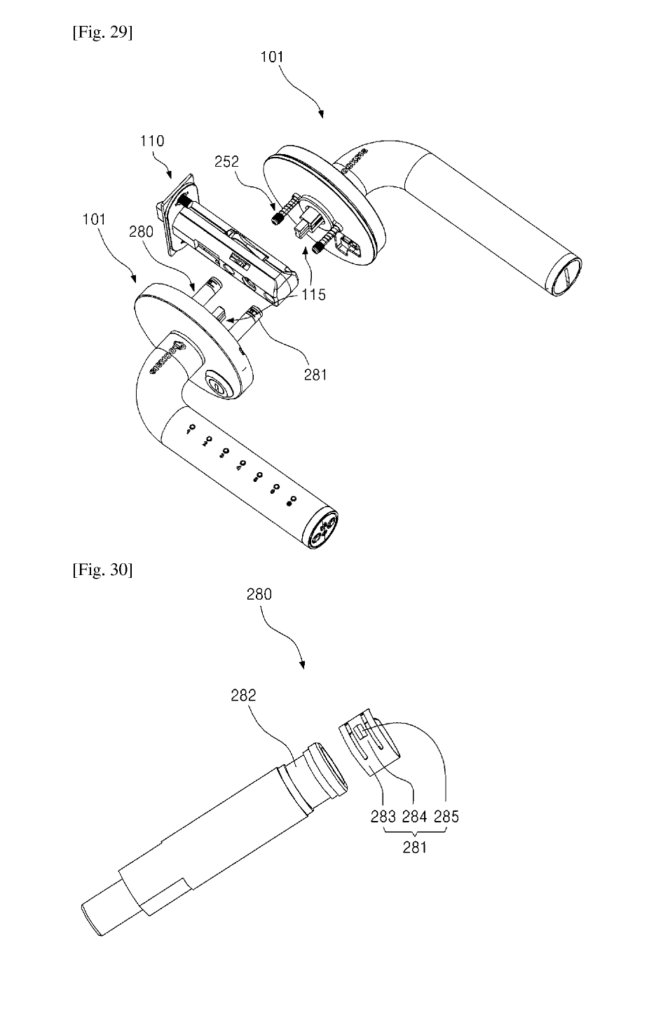

As shown in FIGS. 33 and 34, in a rotary housing 308 and a rotary connection module 320 according to another embodiment of the rotary housing 108 and the rotary connection module 115 shown in FIGS. 28 and 29, the rotary connection module 320 is movably inserted in a slide passage 309 of the rotary housing 308.

The rotary connection module 320 has an integrated structure and is supported by a pressing spring 327 disposed in the slide passage 309 of the rotary housing 308, so it can be connected to the door latch module 110 in an elastic bias state in which it protrudes through an opening at a side of the slide passage 309. The pressing spring 327 may be restricted in the slide passage 309 by being supported on a spring support 322 coupled to the rotary housing 308 and closing the opening at the other side of the slide passage 309.

Further, the rotary housing 308 may have a wire passage groove 333 divided from the slide passage 309 by a separation wall 332. The wire passage groove 333 is not interfered with parts around due to movement of the rotary connection module 320, when a wire (not shown) is disposed through the rotary housing 308, and has a width substantially as large as the slide passage 309, so a plurality of wires can be appropriately arranged.

It is apparent to those skilled in the art that the present invention is not limited to the embodiments described above and may be changed and modified in various ways without departing from the spirit and scope of the present invention. Therefore, those changes and modifications should be construed as being included in claims of the present invention.

1. A digital door lock comprising:
a pair of door lock main bodies that are combined with rotatable levers and disposed on an interior side and an exterior side of a door; and
a rotary connection module that is connected with the levers and rotatably combined with the door lock main bodies to transmit a rotation force of the levers to the door latch module,
wherein the door lock main bodies each include:
a rotary housing that is disposed between the levers and the rotary connection module and has a left-handed lever section for transmitting a clockwise rotation force of the levers to the rotary connection module and a right-handed lever section for transmitting a counterclockwise rotation force of the levers to the rotary connection module; and
a section moving portion that is disposed at side of the rotary housing to be moveable to any one of the left-handed lever section and the right-handed lever section of the rotary housing, and is moved in any one of the left-handed lever section and the right-handed lever section.

2. The digital door lock of claim 1, the door lock main body further includes a door lock body that has a rotary coupling hole in which the lever and the rotary housing are rotatably inserted, and has a locking portion groove in which the section moving portion is disposed and that communicates with the rotary coupling hole.

3. The digital door lock of claim 1, wherein the section moving portion includes:
a rotation-setting support that is disposed in the locking portion groove and protrudes to the rotary coupling hole; and
a rotation-setting spring that is disposed in the locking portion groove and supports the rotation-setting support to an inner wall of the door lock body.

4. The digital door lock of claim 1, wherein the door lock main body further includes a rotary return unit that is combined with the rotary housing, is disposed on the door lock body, and returns the lever to the initial position within the left-handed lever section and the right-handed lever section.

5. The digital door lock of claim 4, wherein the rotary return unit includes:
a rotary plate that is combined with the rotary housing and has a rotary locking protrusion locked to the rotary housing;
a rotary return arm that is connected to the rotary plate and extends to the outer side of the door lock body;
a spring locking plate that is combined with the rotary return arm; and
a rotary return spring that is disposed circumferentially on the door lock body and supports the spring locking plate.

6. The digital door lock of claim 1, wherein the door lock main body further includes:
a return path provider that is combined with the door lock body and provides a spring return path along a rotation path of the spring locking plate so that a pair of rotary return springs are circumferentially arranged; and
a spring cover that is combined with the return path provider and prevents the pair of rotary return springs from separating from the spring return path.

7. The digital door lock of claim 1, wherein the rotary connection module is movably inserted in a slide passage formed in the rotary housing, and
a pressing spring that supports the rotary connection module is disposed in the slide passage of the rotary housing.

8. The digital door lock of claim 1, comprising:
a door latch module that is disposed between the pair of door lock bodies and includes a latch bolt for locking and unlocking the door to and from a doorframe;
a rotary connection module that is connected with the levers and rotatably coupled to the pair of door lock main bodies to transmit a rotation force of the levers to the door latch module; and
a locking/unlocking module that is disposed in the door lock main body to prevent and allow rotation of the rotary connection module,
wherein the locking/unlocking module includes:
a driving unit that is disposed in the door lock body;
a clutch unit that is disposed in the door lock body and prevents and allows rotation of the rotary connection module by being operated by the driving unit; and
a slip gear unit that is disposed on a rotary shaft of the driving unit and connects/disconnect torque transmission between the driving unit and the clutch unit in accordance with torque.

9. The digital door lock of claim 8, comprising:
a sip gear that is engaged with the clutch unit, is movable along the rotary shaft, is combined with the rotary shaft to be rotatable on the rotary shaft, and has any one of the plurality of slip protrusions and the slip protrusion seat grooves; and
a gear mount that is combined with the rotary shaft to rotate with the rotary shaft and has any one of the plurality of slip protrusions and the slip protrusion seat grooves.

10. The digital door lock of claim 8, wherein the slip gear unit further includes a gear support spring that is disposed on the rotary shaft and supports the slip gear.

11. The digital door lock of claim 8, wherein the driving unit includes:
a motor that operates the rotary shaft;
a supporting plate that is disposed on the rotary shaft and supports the slip gear; and
a reducer that is engaged with the rotary shaft an the motor.

12. The digital door lock of claim 10, wherein the slip gear unit further includes:
a slip washer that is disposed on the rotary shaft to support the gear support spring on the supporting plate; and
a stop ring that is combined with the rotary shaft and fixes the gear mount.

13. The digital door lock of claim 9, wherein the clutch unit includes:
a rack gear portion that has a rack gear to be engaged with the slip gear unit and move; and
a clutch portion that is combined with the rack gear unit and moves, and has a clutch pin connecting/disconnecting rotation of the rotary connection module.

14. The digital door lock of claim 1, wherein the door lock main body includes:
a door lock body that is combined with a rotatable lever, has a rotary coupling hole at the position where the lever is disposed, and is combined with the clutch unit;
a locking cam that is disposed on the door lock body and moves the clutch portion in cooperation with a key; and
a rotary housing that is combined with the lever, is rotatably combined in the rotary coupling hole of the door lock body such that the rotary connection module rotates with the lever, and has a stopper groove in which the clutch pin is inserted and locked.

15. The digital door lock of claim 9, wherein the clutch unit further includes a cam guide that is pressed by the locking cam.

16. The digital door lock of claim 14, wherein the lever includes:
an authentication unit for operating the driving unit; and
an inclination sensor that generates a signal sensing a rotation angle of the lever, when the lever is rotated.

17. The digital door lock of claim 1, comprising:
a rotary connection module that is connected with the lever and is rotatably mounted on the pair of door lock main bodies to transmit a rotation force of the lever to the door latch module;
a locking/unlocking module that is disposed on the door lock main body to prevent and allow rotation of the rotary connection module; and
an operation button module that is disposed on the lever to operate the locking/unlocking module, has a plurality of coupling holes in which a plurality of authentication buttons are disposed, and has coupling passages so that coupling tools for inserting the plurality of authentication buttons into the coupling holes are separably combined.

18. The digital door lock of claim 17, wherein the operation button module includes a touch sensor that individually recognizes the authentication buttons by sensing static electricity transmitted through the authentication buttons.

19. The digital door lock of claim 19, wherein the operation button module includes:
an operation button body that is inserted in the lever, has the plurality of coupling holes spaced from each other in a line, and includes button bases disposed such that the coupling passages cross the plurality of coupling holes; and
button elastic members that are disposed in the coupling holes of the button bases and elastically support the authentication buttons.

20. The digital door lock of claim 17, wherein the authentication button includes:
a button body that has a through-hole to communicate with the coupling passages and is inserted in the coupling hole; and
a button portion that protrudes on the button body.

21. The digital door lock of claim 17, wherein the button bases are provided in a pair spaced from each other such that the authentication buttons are arranged over and under the lever, and
the operation button module further includes a controller that is disposed in a controller hole between the pair of button bases and unlocks the door by operating the locking/unlocking module in response to a signal from the authentication buttons.

22. The digital door lock of claim 21, wherein the operation button module further includes an inclination sensor that generates a signal about a rotation angle of the lever to the controller so that the rotation angle of the lever is sensed, when the lever is rotated.
